(19) United States
(12) Patent Application Publication
(10) Pub. No.: US 2025/0269433 A1
(43) Pub. Date: Aug. 28, 2025

(54) DEFORMATION CORRECTION FOR ADDITIVE MANUFACTURING

(71) Applicant: Freeform Future Corp., Hawthorne, CA (US)

(72) Inventors: Tasso Lappas, Pasadena, CA (US); Joseph Benzaken, Monrovia, CA (US)

(21) Appl. No.: 19/062,409

(22) Filed: Feb. 25, 2025

Related U.S. Application Data
(60) Provisional application No. 63/558,234, filed on Feb. 27, 2024.

(51) Int. Cl. B22F 10/85; B22F 10/366; B22F 12/41; B22F 12/90; B33Y 10/00; B33Y 50/02

(52) U.S. Cl. CPC B22F 10/85; B22F 10/366; B22F 12/41; B22F 12/90; B33Y 10/00; B33Y 50/02

(57) ABSTRACT

Determining, avoiding, and/or correcting deformations in additive manufacturing, such as powder-bed fusion, are disclosed. Layers of a part are determined, and a thermal model is associated with a propagation of heat between first layers of the part and second layers of a part during performance of a lasing task. Based on the propagation of heat, an expected deformation of the part is determined. Data is received associated with a melt pool of powdered metal, and an actual deformation of the part is determined. A similarity between the expected deformation and the actual deformation is determined.

### CROSS-REFERENCE TO RELATED APPLICATIONS

This application claims priority to U.S. Provisional Patent Application No. 63/558,234, filed Feb. 27, 2024, entitled “Deformation Correction for Additive Manufacturing,” the entirety of which is herein incorporated by reference.

### BACKGROUND

Additive manufacturing or 3D printing offers multiple benefits over traditional manufacturing processes. For example, additive manufacturing allows more complex parts to be manufactured, eliminating many design constraints of previous manufacturing processes. Additionally, additive manufacturing reduces material costs and waste. However, thus far, print times are relatively long and throughput is low compared to conventional manufacturing processes. Additive manufacturing techniques are also less robust, stable, and/or repeatable compared to traditional manufacturing processes. Accordingly, there is a need for improvements to additive manufacturing processes and techniques.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features. The systems depicted in the accompanying figures are not to scale and components within the figures may be depicted not to scale with each other.

FIG. 1 illustrates an example of a 3D printing system used to manufacture parts and determine deformations within the parts, according to examples of the present disclosure.

FIG. 2 illustrates an example scenario for determining lasing tasks within layer(s) of a part and associating the layer(s) of the part with thermal model(s), according to examples of the present disclosure.

FIG. 3 illustrates an example association of slab(s) of a part to model a propagation of heat throughout the layer(s), according to examples of the present disclosure.

FIG. 4 illustrates an example process for determining layer(s) of a part and associating the layer(s) with one another, according to examples of the present disclosure.

FIG. 5 illustrates an example process for determining deformations within a part, according to examples of the present disclosure.

FIG. 6 illustrates an example process for correcting deformations within a part, according to examples of the present disclosure.

### DETAILED DESCRIPTION

This application is directed, at least in part, to systems and methods for determining, avoiding, and/or correcting deformations in additive manufacturing, such as powder-bed fusion. In powder-bed fusion, powdered metal is selectively melted using lasers (e.g., laser beam, electron beam, thermal print head, etc.). The lasers may be a component of a lasing module of a 3D printing system, where the laser beams melt powdered metal disposed in a build module of the 3D printing system. In some instances, the build module includes a container for receiving the powdered metal and within or on which the parts are manufactured. As explained herein, the laser beams are steered toward respective positions on one or more build areas to melt the powdered metal. In doing so, the laser beams create melt pools of powdered metal, and as the melt pools solidify, structures of the part are formed. The lasing module may include any number of lasers, which may be individually and/or collectively steerable to specific locations in the build areas. In doing so, parts may be manufactured with increased precision, accuracy, and fewer defects than traditional additive manufacturing techniques.

In some instances, the lasing module may include any number of optical assemblies (e.g., one, two, three, . . . N, where Nis an integer) and/or the optical assemblies may include any number of lasers (e.g., one, two, three, . . . M, where M is an integer). The optical assemblies may also include mirrors (e.g., galvo mirrors) that selectively and individually steer the laser beams toward particular locations on the build areas. The optical assemblies also include lens(es) that adjust a spot size or focal length of the laser beams on the build areas. Further, imaging sensor(s) (e.g., high-speed cameras) of the optical assemblies may monitor the build area(s), such as a melt pool of the powdered metal, during operation to provide feedback for use in driving and steering the laser beam(s). The mirror(s) and/or lens(es) provide respective paths for the laser beams from the lasers to the powdered metal.

In some instances, the optical assemblies may include one or more beamlets, where individual beamlets include a laser, mirror(s) for steering the laser beam of the laser, lens(es) for adjusting the spot size of the laser beam, an imaging sensor for imaging the laser beam (or more generally, the build area(s)), and so forth. In some instances, individual beamlets may include a first galvo mirror and a second galvo mirror with single-axis steering but may be used to collectively steer the laser beams throughout the build area. In other examples, one or more galvo mirrors with multi-axis steering may steer the laser beams throughout the build areas. Moreover, respective lens(es) in the beam paths may be adjusted (e.g., using a voice-coil, geared, or belt-driven linear actuator) or have their shape adjusted to change the focus (e.g., using piezo-driven deformable mirrors/lenses, deformable refractive surfaces, or other focusing elements).

The imaging sensors (e.g., one or more complementary metal oxide semiconductor (CMOS) imaging sensors, charge-coupled display (CCD) imaging sensors, etc.) detect the location of a melt pool associated with the laser beam(s). For example, the imaging sensor(s) may receive imaging beam(s) corresponding to a location of the melt pool within the build area. The imaging beams may also indicate or be used to determine properties or other characteristics associated with the laser beam and/or the melt pool. For example, the imaging sensors may be used to determine a size, and/or current condition of the melt pool. The detected location, size, and/or condition may be used to improve the accuracy or precision with which the laser beams are steered. For example, depending upon the imaging of the melt pool, the lens(es) and/or mirror(s) may be adjusted to alter a focal length of individual laser beams and/or steer the laser beams to different locations within the build area. Alternatively, an amount of energy emitted via the laser may be adjusted.

In some instances, the imaging beam may be substantially parallel (e.g., overlap, same as, etc.) with at least a portion of a path of the laser beam. For example, to reach the imaging sensors, the imaging beam may traverse a path substantially parallel to a path of a respective laser beam through at least a portion of the optical assembly. In some instances, as used herein, the laser beam may be considered a “forward path” of the beamlet, while the imaging beam may be considered an “inverse path” or “reflected path” of the beamlet. For ease of reference, light reflected from the melt pool that travels from the melt pool to the imaging sensor(s) of the beamlets may be referred to herein as an “imaging beam” or “imaging beams.”

One or more controllers may control the various lens(es), mirror(s), laser(s), imaging sensor(s), and/or other components of the beamlets. For example, each of the beamlets may include a respective controller for controlling components thereof. The controller may cause the mirror(s) to direct the laser beam toward particular locations on the build areas and may cause the lens(es) to adjust for altering the focal length of the laser beam (e.g., based on the imaging beam(s)), may control an intensity of the laser beams, may turn on and off the laser for different periods, and so forth. The mirror(s) and/or lens(es), as noted above, may also alter the characteristic(s) of the laser beam (e.g., spot size, focal length, etc.).

Adjustment to the characteristic(s) of the laser beam may occur in situ while the laser beams are melting powdered metal. Additionally, or alternatively, characteristic(s) may be altered after manufacturing of a part to affect subsequent manufacturing of other parts. In some instances, a control system (e.g., central controller) or other computing device of the 3D printing system may control the plurality of controllers disposed across the optical assemblies and/or beamlets. The control system may individually control the beamlets or collectively control the beamlets. Alternatively, the beamlets themselves may include computing components for controlling such operations.

The lasers may be instructed to perform lasing tasks across layers of a part. For example, to form a layer of a part, any number of the lasing tasks may be performed. Each lasing task may have a specific size, shape, properties, etc. Additionally, the lasing tasks may be associated with a particular order, such as a specific time in which the lasing tasks are to be performed (compared to the other lasing tasks), an amount of energy required to perform the lasing task (e.g., to melt the powdered metal), temperatures involved during melting of the powdered metal, stresses introduced to the part, strains introduced to the part, and so forth. As explained herein, the imaging beams may be captured during manufacture and used to determine characteristic(s) of the melt pool, such as the amount of energy (e.g., heat) of the melt pool, the temperature of the melt pool, and so forth. In some instances, imaging the melt pool may be used to infer the temperature of the melt pool, strains associated with the temperature, stresses related to the temperature, the amount of energy the laser beam(s) apply to achieve the temperature, and so forth.

The temperature, or more generally the energy associated with the melt pool, and the performance of the lasing tasks may impart strains and stresses into the part. For example, during a lasing task, energy (i.e., heat) is imparted into the powdered metal and/or the part to melt the powdered metal. The energy is introduced to a thin layer of powdered metal disposed on the topmost layer of the part currently being manufactured. The energy, however, is propagated throughout previous layers of the part that have already been manufactured and/or across the same layer in which the lasing task is located. This energy is absorbed by the part (e.g., across the same or different layers) and may lead to differential thermal expansion that may affect the shape, grain structure, etc., of the part. This process repeats throughout manufacturing as the lasing tasks are performed, and, as a result, the layers of the part (or areas of the layers) experience cyclical thermal loading (e.g., hot areas expand, cold areas contract). Upon completion of the part, such as when all of the lasing tasks across the layers of a part have been performed, the cyclical thermal loading may result in deformations. This may cause the part to have an unexpected size, shape, surface finish, etc. Moreover, if the stresses are sufficient, they may lead to cracks and stress fractures in the finished part.

To account for these deformations, the 3D printing system (e.g., the controller) may determine expected or predicted characteristics associated with the lasing task before performing the lasing task. The expected characteristics may include the temperature of the melt pool, the strain of the melt pool, the energy associated with the melt pool, the size of the melt pool, etc. The expected characteristic(s) of the lasing task may be used to determine how the powdered metal, or more generally, the part, is expected to respond. For example, the lasing task may impart a predetermined amount of strain into the part based on the temperature, size of the melt pool, previous lasing tasks, etc.

The strain may create deformations in the part, and understanding, minimizing, and/or accounting for these deformations is crucial in manufacturing parts with desired or expected characteristics. In some instances, the expected characteristics may be modeled and/or associated with a specific size, shape, mass, density, material properties, stresses, strains, etc., introduced into the part. In some instances, the expected characteristics may be associated with an expected deformation of the part. The expected characteristics and/or the expected deformation may be accounted for in the lasing tasks for the part. Knowing the deformations in the part before the performance of the lasing tasks allows those deformations to be compensated for as part of or during manufacturing. For example, because the deformations may lead to distortions within the part, the part may be re-designed so that the deformations are considered. In this sense, the part may be designed with a pre-distortion, such as the strains introduced during the lasing tasks, and the finished part may include desired properties (e.g., size and shape). The predetermined deformations are accounted for and compensated for so that as the part is manufactured and strains are introduced, the final part is produced with the desired properties.

The instructions communicated to the optical assemblies, which the lasers are expected to carry out, may be associated with the expected characteristics. The lasing tasks are based on the expected characteristics that have expected deformations. However, while the expected characteristics may be determined ahead of time, the actual performance of the lasing task may result in actual characteristics that may be different from the expected characteristics due to various factors. For example, these factors may include material imperfections or impurities, variations in laser characteristics, environmental conditions, gas flow velocity fluctuations, etc. Knowing that the laser performed the instructed lasing task according to the expected characteristics or that the melt pool has the expected characteristics is essential to understanding the deformations. For example, if the part is manufactured with different characteristics than expected, the part will have unknown deformations that have not been accounted for in the lasting tasks or design of the part. As a result, the part may be manufactured with unknown and undesired deformations.

In some instances, the imaging beams directed to and captured by the imaging sensor may be used to compare an actual performance of the lasing task with an expected performance of the lasing task in substantially real-time. This may occur during the performance of the lasing task and/or after completion. The imaging beams may be used to determine the actual characteristic(s) of the melt pool and whether the laser beams are performing as expected. In some instances, the imaging beams may be analyzed to understand the actual characteristics. Similar to the expected characteristics, the actual characteristics may include the temperature of the melt pool, the strain associated with the melt pool, and the energy associated with the melt pool. The actual characteristics may be used to determine an actual or expected deformation based on the actual characteristics. If the laser beams are performing as expected, or the characteristics of the melt pool are as expected, the part is manufactured with known characteristics already accounted for in the lasing tasks. A comparison of the actual characteristics to the expected characteristics may be used to understand deviations that occurred or are occurring during the manufacturing of the part.

Monitoring the performance of the lasing task(s), as well as the comparison between the expected and actual characteristic(s), may be used to understand the stresses and strains introduced into a part during manufacture and how these stresses and strains impact a deformation (e.g., mechanical properties) of the part across the layers. If the lasers manufacture the part as expected, then the expected characteristics and the actual characteristics are similar (or within a threshold percentage, amount, etc.). This permits a known understanding of the deformations within the parts. As such, the part will be manufactured with the expected deformations already considered.

As an illustration of a comparison of the expected characteristics and the actual characteristics, take, for example, a tubular part with a desired circular cross-section. Knowing the expected characteristics are used to determine deformations that occur within the part. The lasing tasks account for these deformations by, for example, manufacturing a tubular part with an ovular cross-section. The lasing tasks account for distortions that are expected to occur in the part based on the expected characteristics. As the lasing tasks are performed and strains are input into the part, the strains may cause the ovular cross-section to deform so that the finished part may have the desired circular cross-section. In this manner, although the layers of the part are manufactured with an ovular cross-section, as the layers of the part are manufactured and strains are introduced into the part, the resulting part may include a circular cross-section. That is, the design accounts for the deformations that occur to compensate for the strains introduced to the part during manufacturing. This results in a correction to the expected deformations. As such, the expected deformations of the part are essential to ensure that the part is manufactured as expected. Any deviations may lead to parts with unexpected shapes, sizes, deformations, etc. By way of comparison, if the layers of the part were manufactured with a circular cross-section, the strains introduced during manufacturing may cause the part to distort into the ovular (or another) cross-section. As such, pre-distorting the part may lead to parts with desired shapes.

Whether the laser beams are performing as expected may be used to control the laser beams to optimize properties of the part (e.g., reduce stresses and/or strains, control grain sizes, hardness, etc.) throughout all or one or more localized portions of the part. For example, if the actual characteristics and the expected characteristics are different or by more than a threshold amount, one or more of the lasing tasks may be altered such that the part is manufactured as expected. This may include mapping the actual characteristics to actual deformations in the part and then correcting these deformations so that the part is manufactured as desired. For example, the energy, time, order, etc., of the lasing tasks may be altered to account for the actual characteristics. In some instances, the actual characteristics of a first lasing task may be used to update characteristics of a second lasing task.

In some instances, the expected deformations may be determined using historical data, mechanical model(s), and/or thermal model(s). For example, experimental results may be used to determine how the inputs of a laser beam, or the characteristics of the melt pool, impact, affect, or lead to deformations throughout a part. These deformations, for example, may be determined after manufacturing parts to understand how the input of energy into the part propagates throughout previous layers of a part, layers of the same part, to other lasing tasks, etc. This is made possible via the imaging beams, whereby temperature, energies, etc., associated with a melt pool are captured and mapped to specific stresses, deformations, strains, etc. The propagation may be based on the size of the part, a particular area/location of the part being manufactured, the size or shape of the lasing tasks, the material of the part, characteristics of the laser beam (e.g., incident angle, energy, focal length, etc.), previous lasing tasks having been performed, and so forth. However, as introduced above, imaging beams are utilized to understand the actual characteristics of the part to more accurately understand the thermal propagation throughout the part and infer the deformations of the part. In turn, the thermal model(s) may be updated to more accurately model the propagation of heat and how that impacts the mechanical properties (e.g., size, shape, etc. of the part). In some instances, inputs that are provided to the thermal model(s) may include energy (of the laser beams) and temperature (of the melt pools), and the thermal model(s) may determine the resulting strains, stresses, and deformations applied to the part. In some instances, the thermal model(s) may be used in conjunction with the mechanical model(s) to infer how the part deforms as a result of the lasing task and specific(s) thereof (e.g., energy, size, etc.).

The thermal model(s) may also be used to record a history of the part. For example, the thermal model(s) may be used to record thermal fields within the part as the part is manufactured. This allows for a known history of the part, the temperatures involved during the performance of the lasing tasks, the grain structures of the part, and so forth. This history impacts the mechanical properties and/or fatigue properties of the part. After manufacturing a part, these thermal model(s) provide a record of the part, indicating the grain structure, temperatures, etc., which may be used to understand the mechanical properties and/or fatigue properties.

In some instances, the thermal model(s) may be used to model the deformation(s) at a first instance in time, such as before manufacturing the part, offline, etc., to determine the expected deformations of the part. For example, knowing details of the lasing tasks (e.g., time, energy, etc.) may be used to understand the expected deformations using the thermal model(s). Thereafter, the thermal model(s) may be used to model the deformation(s) at a second instance in time, during manufacturing of the part, online, etc., to determine the actual deformations of the part. For example, knowing the actual characteristics of the lasing tasks once they are performed (e.g., time, energy, etc.) may be used to understand the expected deformations using the thermal model(s).

In some instances, the thermal model(s) may be machine learning (ML) model(s) trained to identify patterns between energy input into a part and a thermal propagation of that energy throughout the part. The ML model(s) may be at least partially trained using the imaging beam(s) from previous lasing tasks, data obtained from the imaging beam(s) from previous lasing tasks, and/or characteristics of parts made during the previous lasing tasks to understand the thermal propagation of energy during the previous lasing tasks and the resulting deformations. Once trained, the ML model(s) may be configured to determine stresses imparted to a part based on image data from one or more imaging beam(s). Data obtained from the imaging beam(s) (e.g., the strain associated with the melt pool, a temperature associated with the melt pool, etc.) may be input into the ML model(s), and the trained ML model(s) may output the resulting stresses throughout the part.

In some instances, the systems and methods described herein utilize a mesh-free approach to model the thermal propagation and stresses imparted to the part. For example, conventional modeling methods require a 3D mesh model of the part to understand deformations due to introducing energy during manufacturing. However, these traditional methods are time-consuming, resource-intensive, and often require human intervention. Additionally, conventional methods fail to accurately detect the performance of the laser beams or the amount of temperature and strain introduced into the part due to manufacturing. That is, conventional methods cannot accurately analyze the melt pool to determine the actual characteristics of the part.

In some instances, the thermal model(s) described herein are applied to slabs of the part to avoid 3D modeling and/or meshing the part. For example, the part may be divided into any number of layers, where each of the layers includes a plurality of the lasing tasks to be performed by the lasers for forming the individual layers. In some instances, the layers of the parts may be grouped into plates, shelves, groups, or slabs. Each slab may include a subset (e.g., group) of the layers of the part. Each slab may include any number of layers (e.g., 2, 5, 10, 25, 100, etc.). For example, in a part with five hundred layers, the part may include fifty slabs (e.g., fifty slabs of ten layers). However, the slabs may include a different number of layers compared to one another, and the slabs may be made up of a greater or lesser number of layers than described.

In some instances, the number of layers per slab may be based at least in part on the contour, shape, and/or size of the part being manufactured and the characteristics of the lasing tasks. For example, the melt pool created by the laser beam(s) may be several layers deep (e.g., from the top-most layer to layers underneath the top-most layer), and the slab(s) may be thicker than the generated melt pool. So, for example, if the melt pool is three layers deep, a slab may include at least four layers. Additionally, the thickness of the slab may be dependent upon the previously manufactured layers.

In some instances, with the thermal model(s), the slabs may be used to model the thermal propagation of heat throughout the part to accurately determine, infer, or predict deformations of the part. For example, as briefly introduced above, as the part is manufactured, layer by layer, heat is applied to the topmost layer during the melting of the powdered metal. This heat propagates throughout the layers of the part and is absorbed by the layers of the part, such as those layers that have already been manufactured. This propagation of heat results in thermal expansion throughout the part, leading to deformation. However, the deformations may be accounted for (e.g., pre-distortion) during the manufacturing of the part. Although described herein as modeling the propagation of heat between slabs, the thermal model(s) may be used to measure the propagation of heat horizontally and/or vertically within individual slabs or layers of the slab. For example, thin shell approximation, thin plate approximation, and/or dynamic mode decomposition techniques may be used to model the horizontal propagation of heat.

The slabs may be mathematically correlated or associated with one another to model the thermal propagation. For example, a first slab may include first layers, and a second slab, vertically below the first slab, may be made of second layers. Performing a lasing task on the topmost layer of the first slab introduces strain into the first layers of the first slab as well as the second layers of the second slab. The first slab and the second slab may be correlated to understand how the stress propagates into the second layers (e.g., location, amount, etc.). Here, the thermal model(s) may model the propagation of heat through the first layers based on the location of the melt pool, the size (or geometry) of the melt pool, the temperature of the melt pool, and so forth. For example, applying heat to a specific area on a layer of the first slab results in heat propagation throughout the first slab, into the second slab, and so forth. The same is true, for example, for a third slab with third layers located vertically below the second slab, and so on. As such, each slab may be correlated to one another to model thermal propagation. Accordingly, due to a specific input on a layer to perform a lasing task, the input may be propagated throughout the slabs to determine the resulting stresses through the correlation between the slabs (via the thermal model(s)). The mechanical model(s) may use the stresses to infer the deformations of the part (i.e., physical deformations).

In some instances, the slabs may act as a unit compared to being modeled in isolation. For example, while each slab may operate independently, each of the slabs may be correlated with one another to form a network of communication (e.g., links) that models how heat propagates throughout the slabs. This heat is used to model stresses imparted into the part and resulting deformations that occur. Given the connectedness between the layers, a need exists to model how heat propagates throughout the layers. The thermal model(s) are used to model how the heat propagates throughout an individual slab and how the heat propagates to other slabs. The thermal model(s) are used to “connect” the slabs together as a way to transfer information (e.g., heat) between the slabs without assembling or modeling the slabs together.

During manufacturing of the part, the imaging beams may be used to ensure that the lasing tasks, or more generally, manufacturing of the part is performing as expected. During this, the deformations within the parts are monitored (e.g., actual). If the process performs as expected, the deformations within the part are known. Knowing the deformations that occur permits those deformations to be corrected or undone in future instances (e.g., in the case of a circular cross-sectional tube, as noted above). By contrast, if the deformations are unexpected or the melt pool cannot be imaged to determine the actual characteristic(s), then the process cannot determine how to correct the deformations. If, during the manufacturing process, the laser beams deviate from their expected operation, the imaging beams may be used to update the actual deformations within the part. These actual characteristic(s) of the updated part may be used to update the thermal model(s) to model thermal propagation throughout the part more accurately. For example, if the actual deformations are outside certain thresholds (or error boundaries/bars), the actual deformations may be used to retrain the thermal model(s).

In some instances, thin-shelled approaches or sign distance fields (SDFs) may be used to model the strains introduced into the part and the deformations. The thin-shelled approach may require the slabs to be thinner and used in the SDFs. In SDF, each slab is volumetrically described by using a distance to the nearest surface. For example, an SDF may receive a position as an input and output a distance from that position to the closest boundary or surface of a shape. Whether thin-shell approaches or SDFs are used may be based on available computing components or resources. In some instances, if central processing units (CPUs) are available, a thin-shell approach may be used. Alternatively, SDF may be used if graphical processing units (GPUS) are available. This is partly because SDFs may be more computationally intensive and require increased computing offered by GPUs. However, thin-shell and SDFs may eliminate 3D or tetrahedral meshing regardless of the specific approach.

In some instances, after completion of a part, the part may be scanned to determine the actual deformation, shape, size, etc. For example, scanners, imagers, etc., may image the part to create scan data. In some instances, the scan data may be analyzed to learn how energy, temperature, or other characteristics of the lasing tasks or the melt pool impact deformation. In turn, the scan data may be used to model the impact of such characteristics on the deformations more accurately. In some instances, the scan data may be used to retrain the thermal and/or mechanical models. In some instances, labels may be applied to the scan data as part of a supervised learning approach for training the thermal models and/or the mechanical models. The scan data may be used in addition, or in alternative to the imaging beams captured during the performance of the lasing tasks to correct for the deformations in the part and/or to train the thermal models and/or the mechanical models. For example, the scan data and the imaging beams may be associated with one another to correlate deformations as determined from the scan data with characteristics of the melt pool as determined from the imaging beams.

The imaging beams may be used to record, store, etc., a history of the part, temperatures, strains, etc., introduced to the part during manufacturing. In some instances, following the completion of the part, the history of the part, which may indicate the temperatures, strains, grain structure, etc., may be provided to purchasers. The imaging beams offer a history of the part that indicates its characteristics.

Additional details of the lasing modules, the build modules, and/or the 3D printing system are described in, for example, U.S. patent application Ser. No. 17/944,883, filed Sep. 14, 2022, entitled “Lasing Module for 3D Printing System,” U.S. patent application Ser. No. 17/944,901, filed Sep. 14, 2022, entitled “3D Printing System with Moving Build Module,” and/or U.S. patent application Ser. No. 18/101,408, filed January 25, 2023, entitled “Scheduling Lasing Tasks of 3D Printing System,” the entirety of which are herein incorporated by reference.

The present disclosure provides an overall understanding of the principles of the structure, function, device, and system disclosed herein. One or more examples of the present disclosure are illustrated in the accompanying drawings. Those of ordinary skill in the art will understand that the devices and/or the systems specifically described herein and illustrated in the accompanying drawings are non-limiting examples. The features illustrated or described in connection with one example may be combined with the features of other examples. Such modifications and variations are intended to be included within the scope of the appended claims.

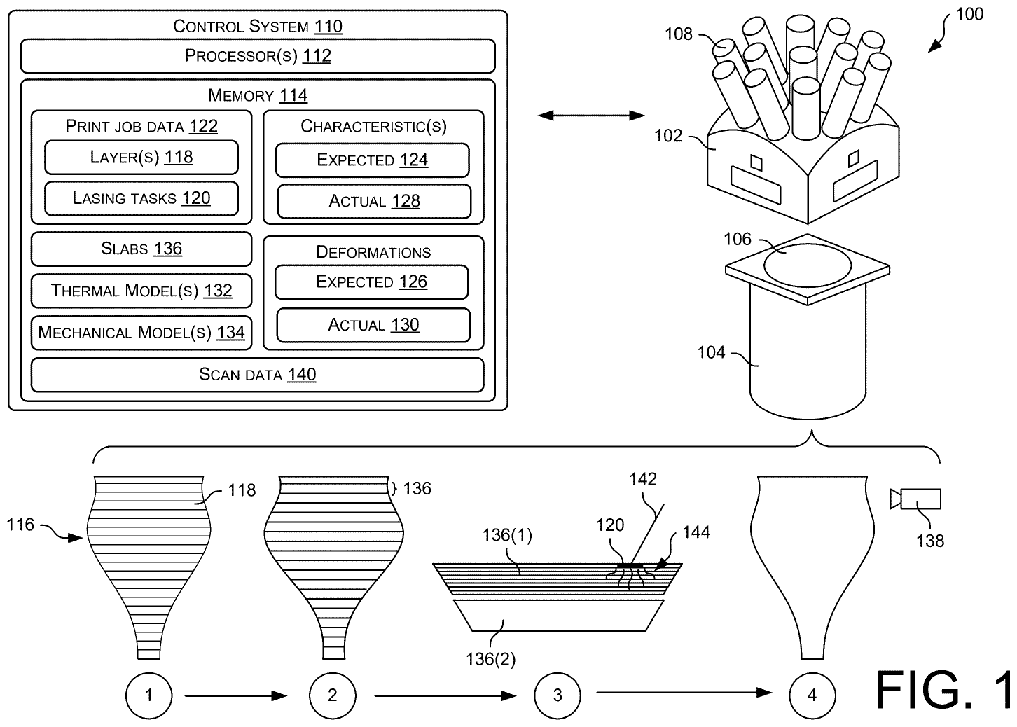

FIG. 1 illustrates an example of a 3D printing system 100 used to manufacture parts, according to examples of the present disclosure. In some instances, the 3D printing system 100 may include a lasing module 102 and one or more build modules 104. The lasing module 102 resides vertically above (e.g., overhead) the build module 104. The build module 104 may be configured to pass underneath the lasing module 102 such that the lasing module 102 builds parts within a bed of powdered material, such as a build area 106, on the build module 104, respectively. In some instances, the build module 104 may be moved underneath the lasing module 102 via a series of conveyors, or the build module 104 may include components (e.g., wheels, motor, drive components, steering components, battery, etc.) for autonomously traversing into and out of the lasing module 102. Although one of the build modules 104 is shown, the lasing module 102 may be configured to manufacture parts across any number of the build modules 104, whether in parallel, sequence, etc. Moreover, the 3D printing system 100 may include more than one of the lasing modules 102.

The lasing module 102 includes a housing (e.g., hood) to which a plurality of optical assemblies 108 are coupled. The optical assemblies 108 may be respectively coupled to sections of the housing. As shown, the optical assemblies 108 may be situated as an array across and about the housing to be oriented towards the build area 106. In some instances, any number of the optical assemblies 108 may couple to the housing, or stated alternatively, the lasing module 102 may include any number of the optical assemblies 108. The shape of the housing (or a portion of the housing to which the optical assemblies 108 couple) permits a greater number of the optical assemblies 108 to be coupled to the lasing module 102.

The optical assemblies 108 may include any number of laser(s) that generate respective laser beams directed towards the build area 106. For example, the optical assemblies 108 may include two lasers, where each laser may generate a laser beam steerable towards the build area 106. In some instances, the laser beams generated by the lasers may be independently or collectively (e.g., clustered) steered (e.g., via galvo mirror(s)) towards locations on the build area 106. As such, the lasers may be used individually and collectively when manufacturing parts. Additionally, lens(es) may control the spot size of the laser beams on the build area 106. An optical pathway of the laser beams may be modified to steer the laser beams toward selective portions of the build area 106 to melt powdered metal, thus creating melt pools at the selected portions of the build area 106. Once cooled or solidified, the melt pool(s) form a part (or a structure of the part).

The optical assembly 108 may include one or more beamlets, where each beamlet includes a laser delivery and imaging subassembly and a focusing and steering subassembly. The laser delivery and imaging subassembly may generate the laser beams from the laser. The laser delivery and imaging subassembly also transmits images of the melt pool toward an imaging sensor of the beamlet. The laser delivery and imaging subassembly may image the melt pool associated with the laser beam of the beamlets, other melt pools associated with other laser beams of other beamlets (e.g., of another optical assembly 108), fiducials on the build module 104, or the build area 106, etc. Each beamlet may include a laser for generating a laser beam and an imaging sensor configured to receive an imaging beam associated with the melt pool. The focusing and steering subassembly serves to focus and steer the laser beams. For example, the focusing and steering subassembly may include various galvo mirror(s) and/or lens(es) that direct the laser beams toward the build area 106. The galvo mirror(s) and/or lens(es) may also direct the imaging beams to the imaging sensor.

The imaging beams represent thermal imaging data of the melt zone (e.g., where the powdered metal is melted) by the laser beams on the build area 106. Images captured by the imaging sensor are used to detect the melt zone, such as a location, as well as characteristics of the melt zone, such as heat, intensity, temperature, etc., for use in determining whether the manufacturing process is successful (e.g., producing parts without defects and with correct structures) as well as to determine characteristic(s) of the part being manufactured. For example, laser beam location, power, focus, and speed may be adjusted based on the analysis of the image(s) of the melt pool.

As explained herein, the imaging beams may be used to determine the specifics of the part being manufactured, that is, what's being melted by the laser beam(s). Knowing the specifics of the part being manufactured permits comparing expected results versus actual results or what the lasers are instructed to do versus what the lasers actually do. That is, while one or more lasers may be instructed to form a portion of a part according to specific characteristics (e.g., amount of heat, duration, angle of incident, etc.), knowing that the portion of the layer of the part was manufactured with the characteristics is essential for quality control. This allows for a manufactured part with known characteristics (e.g., stress, strain, deformations, etc.).

The lasing module 102 is shown being in communication with a control system 110 (e.g., via one or more wired or wireless networks). As shown, the control system 110 may include processor(s) 112 and memory 114, where the processor(s) 112 may perform various functions and operations described herein, and the memory 114 may store instructions executable by the processor(s) 112 to perform the operations described herein. For example, as introduced above, to manufacture a part 116, the part 116 may be segmented into a plurality of layers 118. The layers 118 may represent sections of the part 116 being created. Each successive layer may be printed on top of a previous layer to make the part 116. Within each of the layers 118, one or more lasing tasks 120 are carried out, and the lasing tasks 120 are associated with melting powdered metal within the build area 106. As the layers 118 are formed, the part 116 is manufactured (i.e., layer by layer).

The part 116 may have any number of the layers 118 and each of the layers 118 may have any number of the lasing tasks 120. Within each of the layers 118, the lasing tasks 120 represent a piece or segment of the layer 118 to be melted by the laser beams. In some instances, the lasing tasks 120 are defined by boxes, squares, regions, or other areas on the layers 118 that are melted. In some instances, the lasing task 120 may be determined based on the geometry of part 116. In some instances, the lasing tasks 120 may be associated with a maximum area to be manufactured on a layer 118. In this sense, the lasing tasks 120 may be limited to a specific size (or location) corresponding to the overall size of the layer 118. Segmenting the layers 118 into the lasing tasks 120 permits a plurality of lasers to manufacture the layer 118.

The lasing tasks 120 may be associated with a duration, location, order, and/or setting(s). The duration may indicate the amount of time to complete the lasing task 120 for a given laser or laser(s). The location of the lasing task 120 may indicate a location of the lasing task 120 on the layer 118. In some instances, the location may be expressed as coordinate positions (e.g., X and Y) on the layer 118, or the build area 106. The location may also indicate bounds (e.g., perimeter, area, contour, etc.) of the lasing task 120. The order may indicate when the lasing task 120 will be performed relative to other lasing tasks 120. Additionally, setting(s) may indicate the operational parameter(s) of the lasers to complete the lasing task 120. Such setting(s), for example, may indicate a steering of the mirror(s) of the lasing module 102, a spot size or focal length of the laser beams, whether lasers are to be clustered, etc. The setting(s) may also indicate the power or energy required to melt the powdered metal, the temperature to melt the powdered metal, etc. Still, the setting(s) may include laser power, laser focus, laser beam velocity on the build area 106, the size of the lasing task 120 (e.g., the extent of the lasing task relative to the build area 106, or other lasing tasks 120), an angle of incidence of a laser relative to the build area 106, an orientation of the lasing task 120 on the build area 106, and so forth. As explained herein, the settings may assist in determining characteristic(s) of the lasing task 120, the resulting part 116 being manufactured, and so forth. The lasing task 120 may be stored with the setting(s).

The lasers are scheduled to perform the lasing tasks 120 for manufacturing the layers 118 of the part 116, while the lasing tasks 120 are associated with a time at which the lasers are to perform the lasing tasks 120, respectively. In some instances, scheduling the lasing task 120 may be based on constraints of the 3D printing system 100, the lasers, and/or the part 116 being manufactured. For example, some of the lasing tasks 120 within the layers 118 may be designated as being performed before other lasing tasks 120, or specific lasers may have geometrical constraints limiting regions on the build module 104 that the lasers may target. Additionally, in some instances, a schedule of the lasing tasks 120 may be updated during operation (e.g., in real-time or substantially real-time) based on changing conditions of the 3D printing system 100, such as unexpected delays in manufacturing, decommissioning of lasers, a change in a microstructure of the powdered metal, etc.

In some instances, the lasing tasks 120 may be associated with the same or different-sized regions, and each lasing task 120 may be assigned to a single laser or multiple lasers. For example, multiple lasers of the lasing module 102 or a single laser of the lasing module 102 may be assigned to complete a lasing task 120. Completing the lasing tasks 120 for a particular layer 118 results in a manufactured layer of the part 116. In other words, once a set of the lasing tasks 120 is completed for a given layer 118, the layer 118 of the part 116 is completed. Therein, powdered metal may be deposited on the build area 106 (i.e., as a thin layer of powdered metal) and the lasing tasks 120 to melt the powdered metal of that layer may subsequently be carried out.

Before performing the lasing task 120, the 3D printing system 100 or the control system 110 may determine an expected (i.e., predicted) performance of the lasing task 120. The expected performance may be associated with how the powdered metal will respond when the lasing tasks 120 are performed. However, while the expected performance may be determined ahead of time, the actual performance (i.e., how the powdered metal is actually melted) may differ from the expected performance. This difference may be due to various factors, such as material imperfections or impurities, variations in laser characteristics, environmental conditions, etc. Knowing that the laser performed the instructed lasing task 120, according to the setting(s), is essential to understand any deformation(s) within the part 116. The imaging beams may be used to compare an actual operation of the lasing task 120 with an expected operation of the lasing task 120 in substantially real-time during the performance of the lasing task 120 and/or after completion of the lasing task 120. This comparison may be used to understand the stresses and strains introduced into the part 116 during manufacturing and how those stresses and strains will impact a deformation of the part 116 across the layers 118.

The memory 114 is shown storing or having access to print job data 122. The print job data 122 may correspond to parts to be built within the build module 104. For example, the print job data 122 may indicate sides, surfaces, features, and so forth that make up or form the part 116. The print job data 122 may also indicate the layers 118 of the part 116 to be manufactured. The print job data 122 may be used for scheduling lasers of the optical assemblies 108 to melt areas of the powdered metal. The print job data 122 may be used by the control system 110 to control or instruct the lasing module 102 to manufacture the part 116. For example, depending upon specifics of the part 116, a particular layer 118 of the part 116, or a specific lasing task 120, the control system 110 may transmit instructions to the lasing modules 102, respectively, for steering mirror(s) towards a particular location on the build area 106. The instructions may be associated with the lasing task 120 such that lasers carry out the lasing task 120 in accordance with the instructions. For example, the instructions may indicate an amount of energy emitted by laser(s) of the lasing module 102 and/or a focal point of the lens(es) of the optical assemblies 108.

In accordance with the instructions, the part 116 may be manufactured with characteristic(s). The characteristic(s) may include, or be associated with, deformations formed within or introduced into the part 116. For example, suppose that to perform a lasing task 120, a laser is instructed to melt an area of the powdered metal on the build area 106 with a specific energy over a certain period. During the performance of the lasing task 120, the energy (i.e., heat) is imparted into the part 116 given the melting of the powdered metal. The energy is introduced to a top-most layer of the layers 118 (i.e., the layer 118 of the part 116 being manufactured). However, the energy is propagated throughout previous layers 118 of the part 116 that have already been manufactured and/or the layer 118 of the part 116 currently being manufactured (e.g., horizontally). As the energy is propagated the energy is absorbed by the part 116 and may lead to differential thermal expansion. This repeats throughout the manufacturing process, during which the part 116 experiences cyclic thermal loading. However, deformations are often present upon completion, and the part 116 may include an unexpected size, shape, surface finishes, etc. Moreover, the part 116 may include cracks and stress fractures. In some instances, the characteristic(s) may be associated with the deformation(s).

Understanding the deformations is crucial to manufacturing the parts with desired or expected characteristic(s) 124. For example, the characteristic(s) expected of the part 116 may be determined before manufacturing such that the part 116 may be modeled with a specific size, shape, stresses, strains, etc. The instructions communicated to the optical assemblies 108, which the lasers are expected to carry out, may be associated with the expected characteristic(s) 124. In order words, if the lasers perform the lasing tasks 120 as expected, the resulting part 116 will have expected deformations 126. While the expected characteristic(s) 124 may be known before manufacturing, the imaging beams may be used to understand actual characteristic(s) 128 of the lasing task 120, or the melt pool, during manufacturing. That is, while the laser may be instructed to perform the lasing task 120 (i.e., expected, predicted, etc.), knowing that the laser actually performed the lasing task 120 or that the lasing task 120 was performed according to the expected characteristic(s) 124, with the specified amount of energy to melt the powdered metal, etc., for example, is essential to understand the deformations within the part 116.

In some instances, the expected characteristic(s) 124 may include the temperature of the melt pool, the strain of the melt pool, the energy associated with the melt pool, the size of the melt pool, etc. The expected characteristic(s) 124 may be used to determine how the powdered metal, or more generally, the part 116, is expected to respond. For example, the lasing task 120 may impart a predetermined amount of strain into the part 116 based on the temperature, size of melt pool, previous lasing tasks 120, etc.

The strain may create the deformations in the part 116, and understanding, minimizing, and/or accounting for these deformations is crucial in manufacturing the parts with desired or expected characteristics. In some instances, the expected characteristic(s) 124 may be modeled and/or associated with a specific size, shape, mass, density, material properties, stresses, strains, etc., introduced into the part 116. In some instances, the expected characteristic(s) 124 may be associated with the expected deformations 126 of the part 116. The expected characteristic(s) 124 and/or the expected deformation 126 may be accounted for in the lasing tasks 120 for the part 116. That is, knowing the expected deformations 126 in the part 116 allows for the expected deformations 126 to be compensated for as part of, or during, manufacturing. For example, because the expected deformations 126 may lead to distortions within the part 116, the part 116 may be re-designed to consider the expected deformations 126. In this sense, the part 116 may be designed with a pre-distortion such as the strains are introduced into the part 116 during the lasing tasks 120, the finished part may include desired properties (e.g., size and shape).

The instructions communicated to the optical assemblies 108 may be associated with the expected characteristic(s) 124. The lasing tasks 120 are based on the expected characteristic(s) 124 that have the expected deformations 126. However, while the expected characteristic(s) 124 may be determined ahead of time, the performance of the lasing task 120 may result in the actual characteristic(s) 128 that may be different from the expected characteristic(s) 124 due to a variety of factors. For example, these factors may include material imperfections or impurities, variations in laser characteristics, environmental conditions, gas flow velocity fluctuations, etc.

In some instances, the imaging beams may be used to determine the actual characteristic(s) 128 of the part 116. Similar to the expected characteristic(s) 124, the actual characteristic(s) 128 may include the temperature of the melt pool, the strain associated with the melt pool, the energy associated with the melt pool, etc. The actual characteristic(s) 128 may be used to determine an actual deformation 130 or an expected deformation based on the actual characteristic(s) 128. If the laser beams are performing as expected, or the characteristics of the melt pool are as expected and the deformations within the part 116 are known. Knowing the deformations that occur permits those deformations to be corrected or undone in future instances. By contrast, if the deformations are unexpected or the melt pool cannot be imaged to determine the characteristic(s), then the process cannot determine how to correct the deformations. If, during the manufacturing process, the laser beams deviate from their expected operation, the imaging beams may be used to update the actual deformations within the part 116. A comparison of the actual characteristic(s) 128 to the expected characteristic(s) 124 may be used to understand deviations that occurred or are occurring during manufacturing of the part 116.

In some instances, the expected deformations 126 and/or the actual deformations 130 may be determined using historical data, thermal model(s) 132, and/or mechanical model(s) 134. For example, experimental results may be used to determine how the inputs of a laser beam, or the characteristics of the melt pool, impact, affect, or lead to deformations throughout the part 116. These deformations, for example, may be determined after manufacturing the part 116 to understand how input of energy into the part 116 propagates throughout the layers 118, to other lasing tasks 120, etc. This is made possible via the imaging beams, whereby temperature, energies, etc., associated with a melt pool are captured and mapped to specific stresses, deformations, strains, etc. The propagation of the energy may be based on the size of the part 116, a particular area/location of the part 116 being manufactured, the size or shape of the lasing tasks 120, a material of the part 116, characteristics of the laser beam (e.g., incident angle, energy, focal length, etc.), previous lasing tasks 120 having been performed, and so forth. However, as introduced above, the imaging beams are utilized to understand the actual characteristic(s) 128 of the part 116 to more accurately understand the thermal propagation throughout the part 116 and infer the deformations of the part 116. In turn, the thermal model(s) 132 may be updated to more accurately model the propagation of heat and how that impacts the mechanical properties (e.g., size, shape, etc. of the part). In some instances, inputs that are provided to the thermal model(s) 132 may include energy (of the laser beams) and temperature (of the melt pools), and the thermal model(s) 132 may determine resulting strains, stresses, and deformations applied to the part 116. In some instances, the thermal model(s) may be used in conjunction with the mechanical model(s) 134 to infer how the part 116 deforms as a result of the lasing tasks 120 and specific(s) thereof (e.g., energy, size, etc.).

In some instances, the thermal model(s) 132 may be used to model the deformation(s) at a first instance in time, such as before manufacturing the part 116, offline, etc., to determine the expected deformations 126. For example, knowing details of the lasing tasks 120 (e.g., time, energy, etc.) may be used to understand the expected deformations 126 using the thermal model(s) 132 and/or the mechanical model(s) 134. Thereafter, the thermal model(s) 132 and/or the mechanical model(s) 134 may be used to model the deformation(s) at a second instance in time, during manufacturing of the part 116, online, etc., to determine the actual deformations 130 of the part 116. For example, knowing the actual characteristic(s) 128 of the lasing tasks 120 once they are performed (e.g., time, energy, etc.) may be used to understand the expected deformations 126 using the thermal model(s) 132 and/or the mechanical model(s) 134.

In some instances, the thermal model(s) 132 and/or the mechanical model(s) 134 may be machine learning (ML) model(s) trained to identify patterns between energy input into a part and a thermal propagation of that energy throughout the part 116. The ML model(s) may be partially trained using the imaging beams from previous lasing tasks 120, data obtained from the imaging beams from previous lasing tasks 120, and/or characteristics of the parts made during the previous lasing tasks 120. This may be used to understand the thermal propagation of energy during the previous lasing tasks and the effects on deformations. Once trained, the ML model(s) may be configured to determine stresses imparted to the part 116 based on imaging data from one or more imaging beam(s). Data obtained from the imaging beam(s) (e.g., the strain associated with the melt pool, a temperature associated with the melt pool, etc.) may be input into the ML model(s), and the trained ML model(s) may output the resulting stresses throughout the part 116.

The training data used to train ML model(s) may include various data types. In general, training data for machine learning may include two components, features and labels. However, in some instances, the training data used to train the ML model(s) may be unlabeled. Accordingly, the ML model(s) may be trainable using any suitable learning technique, such as supervised learning, unsupervised learning, semi-supervised learning, reinforcement learning, etc. The features included in the training data can be represented by a set of features, such as in the form of an n-dimensional feature vector of quantifiable information about an attribute of the training data. The following is a list of example features that can be included in the training data for training the ML model(s) described herein. However, it is to be appreciated that the following list of features is non-exhaustive, and features used in training may include additional features not described herein and, in some cases, some, but not all, of the features listed herein. Example features included in the training data may include, without limitation, the location of the lasing task 120, the size of the lasing task 120, setting(s) associated with the lasing task 120, a material used to manufacture the part 116, a size of the part 116, and so forth.

The ML model(s) may represent a single model or an ensemble of base-level machine learning models and may be implemented as any type of machine learning model. For example, suitable machine learning models for use with the techniques and systems described herein include, without limitation, neural networks, tree-based models, support vector machines (SVMs), kernel methods, random forests, splines (e.g., multivariate adaptive regression splines), hidden Markov model (HMMs), Kalman filters (or enhanced Kalman filters), Bayesian networks (or Bayesian belief networks), expectation maximization, genetic algorithms, linear regression algorithms, nonlinear regression algorithms, logistic regression-based classification models, or an ensemble thereof. An “ensemble” can comprise a collection of machine learning models whose outputs (predictions) are combined, such as by using weighted averaging or voting. The individual machine learning models of an ensemble can differ in their expertise, and the ensemble can operate as a committee of individual machine learning models that is collectively “smarter” than any individual machine learning model of the ensemble.

In some instances, the systems and methods described herein utilize a mesh-free approach to model the thermal propagation and stresses imparted to the part 116. For example, conventional methods require a 3D mesh model of the part 116 to understand deformations based on the energy introduced during manufacturing. However, these traditional methods are time-consuming, resource-intensive, and often require human intervention. Additionally, due to manufacturing, conventional methods fail to accurately detect the performance of the laser beams or the amount of temperature and strain introduced into part 116. That is, traditional methods cannot accurately analyze the melt pool to determine the actual characteristics of the part.

In some instances, the thermal model(s) 132, as described herein, are applied to slabs 136 of the part 116 to avoid 3D modeling and/or meshing. For example, the part may be divided into any number of the layers 118, where each of the layers 118 includes a plurality of the lasing tasks 120 to be performed by the lasers for forming the layers 118, respectively. In some instances, the layers 118 of the part 116 may be grouped into the slabs 136, where of the slabs 136 may include a subset (e.g., group) of the layers 118 of the part 116. For example, the slabs 136 may be made up of ten layers and in a part with five-hundred layers, for example, the part may include fifty slabs (e.g., fifty slabs of ten layers). However, the slabs 136 may include a different number of the layers 118 compared to one another, and the slabs 136 may be made up of a greater or lesser number of the layers 118 than described.

In some instances, a number of the layers 118 that make up the slabs 136 may be based at least in part on a contour, shape, and/or size of the part 116 being manufactured, as well as characteristics of the lasing tasks 120. For example, the melt pool created by the laser beam(s) may be several layers deep (e.g., from the topmost layer), and the slabs 136 may be thicker than the generated melt pool. So, for example, if the melt pool extends or is three layers deep, a slab 136 may include at least four layers. Additionally, a thickness of the slab 136 may be dependent upon the previous manufactured layers (e.g., to avoid voids in the part).

The slabs 136 may be mathematically correlated or associated with one another to model the thermal propagation. For example, a first slab may include first layers, and a second slab, vertically below the first slab, may be made of second layers. Performing a lasing task 120 on the topmost layer of the first slab introduces strain into the first layers of the first slab as well as the second layers of the second slab. To understand how the stress propagates into the second layers (e.g., location, amount, etc.), the first slab and the second slab may be correlated with one another. Here, the thermal model(s) 132 may model the propagation of heat through the first layers based on the location of the melt pool, the size (or geometry) of the melt pool, the temperature of the melt pool, and so forth. For example, applying heat to a specific area on a layer of the first slab results in heat propagation throughout the first slab, into the second slab, and so forth. The same is true, for example, for a third slab with third layers located vertically below the second slab, and so on. Accordingly, as a result of a particular input on a layer to perform a lasing task 120, through the correlation between the slabs 136, via the thermal model(s) 132, the input may be propagated throughout the slabs 136 to determine the resulting stresses. The stresses may be used by mechanical model(s) 134 to infer the deformations of the part 116.

In some instances, the slabs 136 may act as a unit compared to being modeled in isolation. For example, while each of the slabs 136 may operate independently, each of the slabs 136 may be correlated with one another to form a network of communication that models how heat propagates. This heat is used to model stresses imparted into the part 116 and the resulting deformations. As such, the thermal model(s) 132 are used to “connect” the slabs 136 together as a way to transfer information (e.g., heat) between the slabs 136 without assembling or modeling the slabs 136 together (e.g., modeling an entirety of the part). In some instances, the slabs 136 and the thermal model(s) 132 allow for the understanding of thermal propagation and stresses imparted to the part 116 without the need for 3D meshing the part 116.

Although described herein as modeling the propagation of heat between the slabs 136, the thermal model(s) 132 may be used to measure the propagation of heat horizontally and/or vertically within individual slabs 136 or within the layers 118 of the slab 136. For example, thin shell approximation, thin plate approximation, and/or dynamic mode decomposition techniques may be used to model the horizontal propagation of heat. Moreover, the mechanical model(s) 134, based on the thermal model(s) 132, may be used to understand the deformations.

In some instances, thin-shelled approaches or sign distance fields (SDFs) may be used to model the strains introduced into the part 116 and the deformations. The thin-shelled approach may require the slabs 136 to be thinner and used in the SDFs. In SDF, each slab is volumetrically described by using a distance to the nearest surface. For example, an SDF may receive a position as an input and output a distance from that position to the closest boundary or surface of a shape. Whether thin-shell approaches or SDFs are used may be based on available computing components or resources. In some instances, if central processing units (CPUs) are available, a thin-shell approach may be used. Alternatively, SDF may be used if graphical processing units (GPUS) are available. This is partly because SDFs may be more computationally intensive and require increased computing offered by GPUs. However, regardless of the specific approach, thin-shell and SDFs may eliminate 3D or tetrahedral meshing.

In some instances, after completing the part 116, the part 116 may be scanned to determine the actual deformation, shape, size, etc. For example, a scanner 138 (e.g., imagers) may scan the part 116 to create scan data 140. In some instances, the scan data 140 may be analyzed to learn how energy, temperature, or other characteristics of the lasing tasks 120 or the melt pool impacts deformation. In turn, the scan data 140 may be used as a way to more accurately model the impact of such characteristics on the deformations. The scan data 140, in some instances, may be used to retrain the thermal model(s) 132 and/or the mechanical model(s) 134. In some instances, labels may be applied to the scan data 140 as part of supervised learning approached for training the thermal model(s) 132 and/or the mechanical model(s) 134. The scan data 140 may be used in addition to, or in the alternative, to the imaging beams captured during performance of the lasing tasks 120 to correct for the deformations in the part 116. For example, the scan data 140 and the imaging beams may be associated with one another to correlate deformations as determined from the scan data 140 with characteristics of the melt pool as determined from the imaging beams.

The imaging beams may be used to record, store, etc., a history of the part 116, temperatures, strains, etc., introduced to the part 116 during manufacturing. In some instances, following a completion of the part 116, the history of the part 116, which may indicate the temperatures, strains, grain structure, etc., may be provided to a purchaser of the part 116. The imaging beams therefore provide a history of the part 116 that indicates its characteristics.

Take, for example, a scenario illustrated in FIG. 1. At “1” the part 116 may be divided into a plurality of the layers 118, where each of the layers 118 includes the lasing tasks 120. At “2”, the layers 118 may be grouped into the slabs 136. As shown, the slabs 136 may be in a vertical stacked relationship, adjacent to one another. The slabs 136 may be correlated with one another in order to model the propagation of heat throughout the slabs 136 upon manufacturing of the part 116. At “3” a lasing task 120 may be performed via a laser beam 142 melting powdered metal on a layer (e.g., top-most) of a first slab 136(1). Although described as a “first” slab, the first slab 136(1) may not be the actual first slab of the part 116. During performance of the lasing task 120, heat 144 is imparted into the part 116 given the melting of the powdered metal. While the heat 144 is introduced to a top-most layer of the part 116, the heat 144 propagates throughout previous layers of the part 116 (within the first slab 136(1)), as well as layers of the slabs 136 that have already been manufactured, such as layers of a second slab 136(2). Although described as a “second” slab, the second slab 136(2) may not be the actual second slab of the part 116. As discussed above, whether the laser beam 142 is performing as expected may be used to control the laser beam 142 to optimize properties of the part 116 (e.g., reduce stresses and/or strains, control grain sizes, hardness, etc.) throughout all or one or more localized portions of the part. This heat 144 is absorbed and leads to differential thermal expansion.

Moreover, an imaging beam associated with the melt pool, or the heat 144, may be used to determine the actual characteristic(s) 128. If the actual characteristic(s) 128 and the expected characteristic(s) 124 are different, or by more than a threshold amount, one or more of the lasing tasks 120 may be altered such that the part 116 is manufactured as expected. This may include mapping the actual characteristic(s) 128 to actual deformations 130 in the part 116, using the thermal model(s) 132 and/or the mechanical model(s) 134. For example, the energy, time, order, etc., of the lasing tasks 120 may be altered to account for the actual characteristic(s) 128. In some instances, the actual characteristic(s) 128 of a first lasing task may be used to update characteristics of a second lasing task 120.

If the process performs as expected, the deformations within the part 116 are known. Knowing the deformations that occur permits those deformations to be corrected or undone in future instances. For example, to produce the part as shown in FIG. 1, the lasing tasks 120 may have pre-distortions in that the part 116 is formed with deformations, but after manufacturing (and the strains are input into the part 116), the finished part may have the desired shape. In this manner, although the layers 118 of the part 116 are manufactured with a pre-distortion, as the subsequent layers 118 are manufactured and the strains are introduced into the part 116, the resulting part 116 includes the desired shape. By contrast, if the deformations are unknown, then the process cannot determine how to correct the deformations.

Upon manufacturing the part 116, at “4” the scanner 138 may be used to generate the scan data 140.

The control system 110 may be implemented as one or more servers and may, in some instances, form a portion of a network-accessible computing platform implemented as a computing infrastructure of processors, storage, software, data access, etc., that is maintained and accessible via a network such as the Internet. The control system 110 does not require end-user knowledge of the physical location and configuration of the system that delivers the services. Common expressions associated with the control system 110 include “on-demand computing”, “software as a service (SaaS)”, “platform computing”, “network-accessible platform”, “cloud services”, “data centers”, etc. However, in some instances, the control system 110 may be located within a same environment as the 3D printing system 100.

As used herein, a processor, such as the processor(s) 112, may include multiple processors and/or a processor having multiple cores. Further, the processor(s) 112 may comprise one or more cores of different types. For example, the processor(s) 112 may include application processor units, graphic processing units, and so forth. In one implementation, the processor(s) 112 may comprise a microcontroller and/or a microprocessor. The processor(s) 112 may include a graphics processing unit (GPU), a microprocessor, a digital signal processor or other processing units or components known in the art. Alternatively, or in addition, the functionally described herein can be performed, at least in part, by one or more hardware logic components. For example, and without limitation, illustrative types of hardware logic components that may be used include field-programmable gate arrays (FPGAs), application-specific integrated circuits (ASICs), application-specific standard products (ASSPs), system-on-a-chip systems (SOCs), complex programmable logic devices (CPLDs), etc. Additionally, each of the processor(s) 112 may possess its own local memory, which also may store program components, program data, and/or one or more operating systems.

Memory, such as the memory 114, may include volatile and nonvolatile memory, removable and non-removable media implemented in any method or technology for storage of information, such as computer-readable instructions, data structures, program component, or other data. Such memory may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, RAID storage systems, or any other medium which can be used to store the desired information and which can be accessed by a computing device. The memory may be implemented as computer-readable storage media (“CRSM”), which may be any available physical media accessible by the processor(s) to execute instructions stored on the memory. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other tangible medium which can be used to store the desired information and which can be accessed by the processor(s) 112. The memory 114 is an example of non-transitory computer-readable media. The memory 114 may store an operating system and one or more software applications, instructions, programs, and/or data to implement the methods described herein and the functions attributed to the various systems.

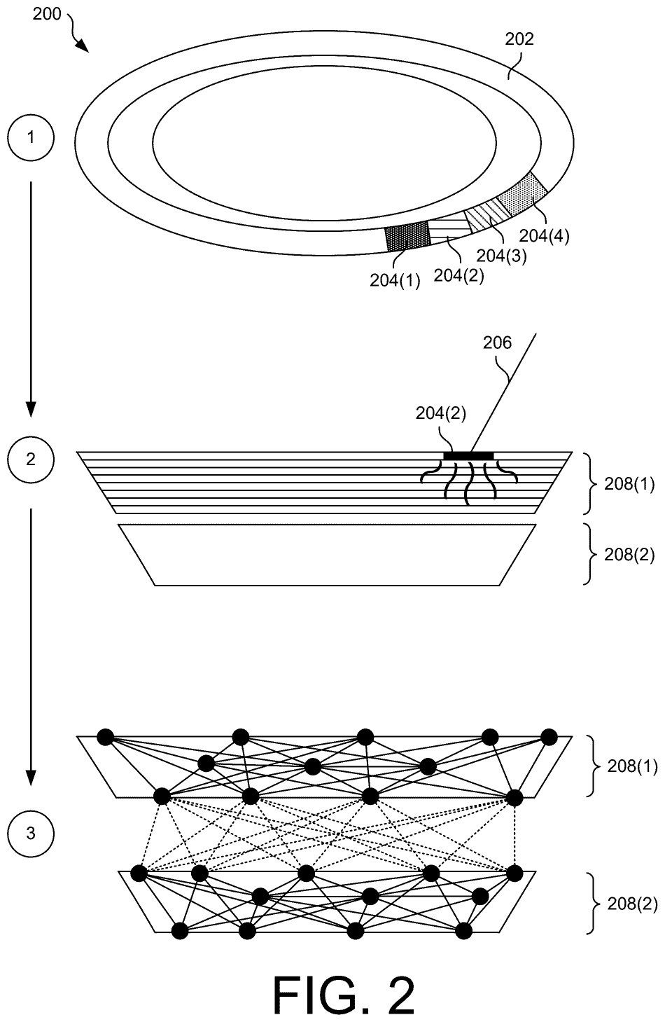

FIG. 2 illustrates an example use of the thermal model(s) 132 to determine deformations within a part 200, according to examples of the present disclosure. Initially, data associated with the part 200 is received and the part 200 is cross-sectioned into a plurality of layers, such as a layer 202. At “1” in FIG. 2, lasing tasks 204 may be carried out for forming the layer 202 of the part 200. For example, to at least partially form the layer 202 of the part 200, a first lasing task 204(1), a second lasing task 204(2), a third lasing task 204(3), and a fourth lasing task 204(4) may be performed. The view shown at “1” in FIG. 2 may illustrate a top isometric view of the part 200.

The plurality of the lasing tasks 204 are shown including boxes, sections, pieces, or other boundary. Each of the lasing tasks 204 represents a task for a laser of the lasing module 102 to complete. For the layer 202, any number of lasers may be used to complete the lasing tasks 204. However, in some instances, only a single laser may be assigned to a given lasing task 204. In some instances, the lasing tasks 204 are determined based on the geometry of the part 200, a size of the layer 202, or may be based on given size constraints of the lasing tasks 204. In some instances, the layer 202 is divided into the lasing tasks 204 using a variety of approaches, schemes, or strategies. For example, the lasing tasks 204 may have a similar spatial envelope with specific dimensions. In some instances, the lasing tasks 204 have a similar length on one or more sides as each other.

At “2” in FIG. 2, one of the lasing tasks 204 may be carried out. For example, a laser beam 206 may melt a portion of the powdered metal corresponding to the second lasing task 204(2). As noted above, during the performance of the second lasing task 204(2), strain is imparted to the layers of a first slab 208(1) and layers of a second slab 208(2) of the part 200. The strain introduced into the part 200 results from the temperature of the melt pool created via performing the second lasing task 204(2).

At “3” in FIG. 2, modeling of the thermal propagation is illustrated. In some instances, the layers of the slabs 208 are mathematically connected and/or correlated via a network. This network represents a relatedness, or connectedness, of different areas of the slabs 208. For example, applying energy at a location on the layer 202 corresponding to the second lasing task 204(2) causes a propagation of that energy throughout the layers of the first slab 208(1), the layers of the second slab 208(2), as well as layers of the other slab(s) 208. That is, although FIG. 2 illustrates thermal model(s) 132 between the first slab 208(1) and the second slab 208(2), thermal model(s) 132 may exist between other slab(s) 208. For example, a third slab vertically below the second slab 208(3) may be correlated with the second slab 208(2) via different thermal model(s). This enables an understanding of how the energy propagates throughout the slab(s) of the part 200 during the performance of the lasing tasks.

The thermal model(s) 132 may be used with the mechanical model(s) 134. While the thermal model(s) 132 indicates the propagation of energy, the mechanical model(s) 134 may model an impact of the propagation of energy on the mechanical structure of the part 200, such as surface finish, deformations, etc. The mechanical model(s) 134 may be determined using outputs of the thermal model(s) 132, where the mechanical model(s) 134 may determine the deformations.

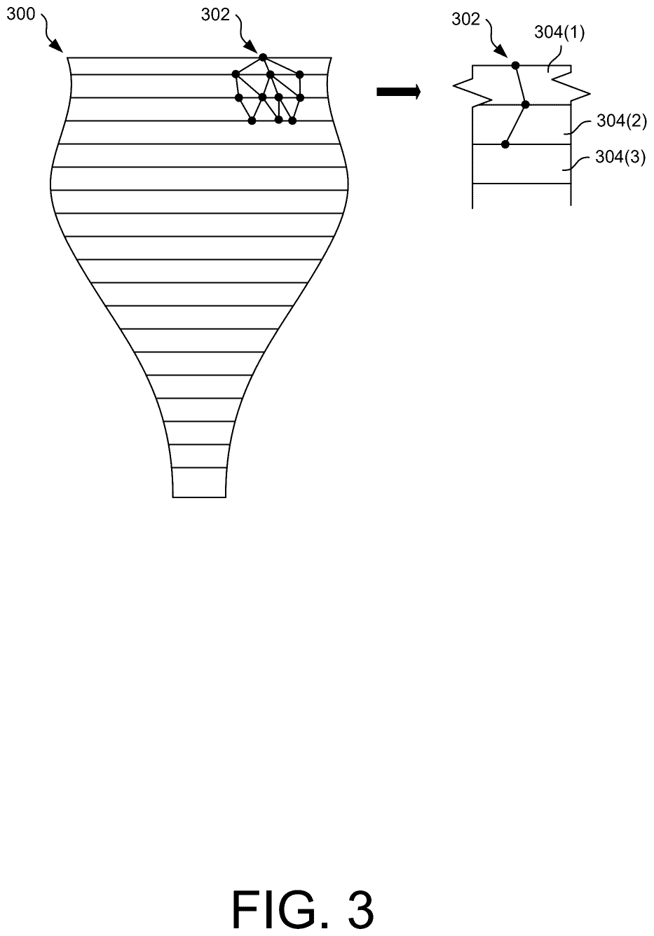

FIG. 3 illustrates an example thermal model 132 associated with a part 300, according to examples of the present disclosure. The thermal model 132 may be used to model the propagation of heat throughout the part 300 as lasing tasks are performed. For example, a lasing task may be performed on a top-most layer of the part 300 and to carry out the lasing task, energy may be applied at a location 302 corresponding to the lasing task. The thermal model 132 indicates how this energy (e.g., strain) propagates through the slab(s) of the part 300 in response to the energy being applied at the location 302. For example, a network of nodes may be used to correlate the slab(s) of the part 300 with one another, where the nodes mathematically connect adjacent slab(s) to model the propagation of strain throughout the part 300.

More particularly, the thermal model(s) 132 may indicate how strain (e.g., as a result of the heat) propagates from a first slab 304(1), to a second slab 304(2), and a third slab 304(3). The thermal model(s) 132 associates the slabs together to model the propagation throughout the slabs. This avoids modeling a 3D mesh of the entire part 300, but instead, the slabs may be correlated with one another, where the output from one slab (e.g., the first slab 304(1) is provided (e.g., as an input) to another slab (e.g., the second slab 304(2)). While a specific number, location, or connectedness of the nodes is shown, more than or less than the number of nodes may be used to connect the slab(s), and/or the nodes may be connected differently than shown. Moreover, the nodes may be located on other slab(s) of the part 300 than shown, for example, and extend further vertically downward on the part than shown.

In some instances, the thermal model may be based on a size of the lasing task, the location on the part 300, the energy required to perform the lasing task, the temperature of the melt pool, the length of time to complete the lasing tasks, prior lasing tasks having been performed, a material of the part 300, and so forth.

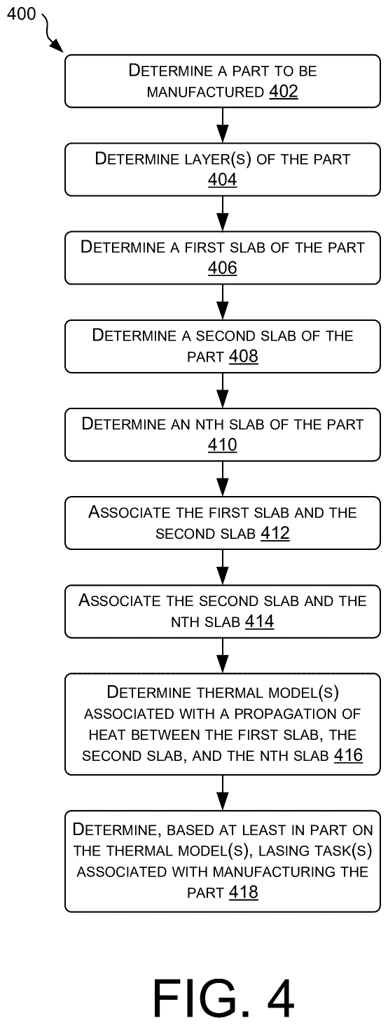

FIGS. 4-6 illustrate various processes related to manufacturing parts using the 3D printing system 100, determining a propagation of heat throughout the parts, determining thermal model(s), and so forth. The processes described herein are illustrated as collections of blocks in logical flow diagrams, which represent a sequence of operations, some or all of which may be implemented in hardware, software, or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation, unless specifically noted. Any number of the described blocks may be combined in any order and/or in parallel to implement the process, or alternative processes, and not all of the blocks need be executed. For discussion purposes, the processes are described with reference to the environments, architectures and systems described in the examples herein, such as, for example those described with respect to FIGS. 1-3, although the processes may be implemented in a wide variety of other environments, architectures and systems.

FIG. 4 illustrates an example process 400 associated with correlating slabs of a part for modeling a propagation a heat throughout the slabs and/or determining a deformation of the part. At 402, the process 400 may include determining a part to be manufactured. For example, the 3D printing system 100 may be responsible for manufacturing parts across the build modules 104 via the lasing modules 102. In some instances, the parts may be manufactured based on a queue of parts to be manufactured, an availability of the lasing modules 102, an availability of the build modules 104, etc.

At 404, the process 400 may include determining layers of the part. For example, based at least in part on the part being manufactured, the part may be segmented into a plurality of layers. In some instances, the part is segmented into the layers based on a certain desired thickness of the layers, dimensions of the part, a material of the part, and so forth. Each of the layers may include a plurality of lasing tasks that are to be performed for forming the layer of that part. For example, when the lasing tasks of a layer of a part are performed, that layer may be completed. This process may repeat until the layers of the part have been manufactured.

At 406, the process 400 may include determining a first slab of the part. For example, the process 400 may group a portion of the layers together. The first slab represents a group of the layers, where the layers of the first slab are adjacent to one another. In some instances, the first slab represents any number of the layers grouped together (e.g., ten, twenty, one hundred, etc.). A thickness, or number of layers that make up the first slab, may be based on a geometry of the part, specifics of the lasing tasks (e.g., size of melt pool), etc. Additionally, a thickness or the number of the layers of the first slab may be based on a process by which the thermal propagation and/or deformations are modeled. For example, thin-shelled approaches or sign distance fields (SDFs) may be used to model the strains introduced into the part and the deformations. If central CPUs are available, thin-shell approaches may be used and the slabs may be thinner than if GPUS are available, whereby the slabs may be thicker.

At 408, the process 400 may include determining a second slab of the part. For example, the process 400 may group a portion of the layers together. The second slab represents a group of the layers, where the layers of the second slab are adjacent to one another. In some instances, the second slab represents any number of the layers grouped together (e.g., ten, twenty, one hundred, etc.). The second slab may be adjacent to the first slab, and the layers that make up the second slab may be different than the layers that make up the first slab. A thickness, or number of layers that make up the second slab, may be based on a geometry of the part, specifics of the lasing tasks (e.g., size of melt pool), etc.

At 410, the process 400 may include determining an nth slab of the part. For example, the process 400 may group a portion of the layers together. The nth slab represents a group of the layers, where the layers of the nth slab are adjacent to one another. In some instances, the nth slab represents any number of the layers grouped (e.g., ten, twenty, one hundred, etc.). The nth slab may be adjacent to the second slab, and the layers that make up the nth slab may be different than layers that make up the second slab (as well as other layers of the part).

At 412, the process 400 may include associating the first slab and the second slab. For example, associating the first slab and the second slab may be used to model how heat (or strain) propagates from the first slab to the second slab, based at least in part on lasing tasks being performed on the first slab, for example. The association may mathematically link the first slab and the second slab as a way to model how the heat from the first slab is transferred to the second slab. Understanding how the heat transfers between the slabs is used to determine, infer, or predict deformations within the part, and allow for those deformations to be accounted for during manufacturing. Mathematically linking the first slab and the second slab may avoid having to model an entirety of the part (e.g., 3D mesh model).

At 414, the process 400 may include associating the second slab and the nth slab. For example, associating the second slab and the nth slab may be used to model how heat (or strain) propagates from the second slab to the nth slab, based at least in part on lasing tasks being performed. The association may mathematically link the second slab and the nth slab as a way to model how the heat from the second slab is transferred to the nth slab.

At 416, the process 400 may include determining thermal model(s) associated with a propagation of heat between the first slab, the second slab, and the nth slab. For example, the thermal model(s) may be used to model how heat (e.g., in response to a lasing task being performed) propagation between the first slab, the second slab, and the nth slab. The thermal model(s) may be based on a material of the part, a size of the part, a location of the lasing task on the part, an amount of energy (e.g., heat) required to melt the powdered metal associated with the lasing task, previous lasing tasks having been performed, and so forth. The thermal model(s) may be used in association with the association of the slabs, in order to model the transfer of heat between the slabs. That is, through the prior association of the slab(s), the thermal model(s) may model a propagation of the heat throughout the slab(s). In some instances, a first thermal model may associate the first slab and the second slab, while a second thermal model may associate the second slab and the nth slab.

At 418, the process 400 may include determining, based at least in part on the thermal model(s), lasing tasks associated with manufacturing the part. For example, using the thermal model(s) and understanding the propagation of energy throughout the slabs of the part may be used to determine deformations in the part. These deformations may be corrected or otherwise compensated for in the lasing tasks. For example, to account for the strains introduced to the part during melting of the powdered metal, the lasing task(s) may be determined. In some instances, the lasing tasks, when performed, account for future lasing tasks and the strains introduced into the part as a result of the future lasing tasks.

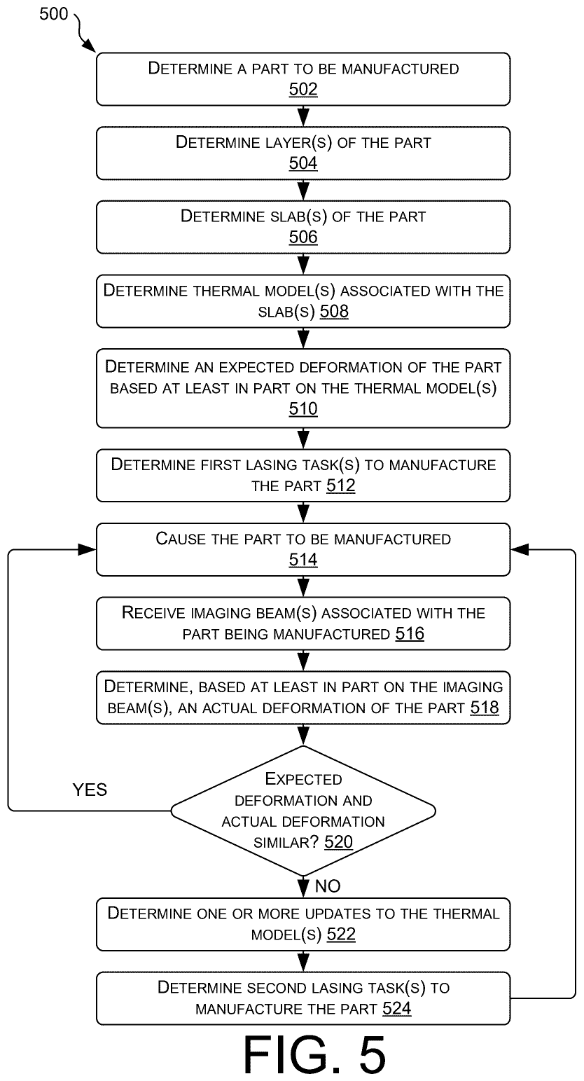

FIG. 5 illustrates an example process 500 associated with determining deformations within a part being manufactured, according to examples of the present disclosure. At 502, the process 500 may include determining a part to be manufactured. For example, the 3D printing system 100 may be responsible for manufacturing parts across the build modules 104 via the lasing modules 102. In some instances, the 3D printing system 100 may access, or have knowledge, into all the parts currently being manufactured.

At 504, the process 500 may include determining layers of the part. For example, based at least in part on the part being manufactured, the part may be segmented into a plurality of layers. In some instances, the part is segmented into the layers based on a certain desired thickness of the layers, dimensions of the part, a material of the part, and so forth. Each of the layers may include a plurality of lasing tasks that are to be performed to form the layer of the part.

At 506, the process 500 may include determining slabs of the part. For example, once the part is segmented into the layers, the layers may be grouped into slab(s). The slab(s) may represent a subset of the layers of the part. For example, slab(s) may include ten layers, twenty layers, etc. In some instances, the slab(s) may include a different number or similar number of layers as compared to one another. As will be explained herein, while the slab(s) may be independent from one another, the slab(s) may be used as a way to model the thermal propagation of heat between the slab(s) and throughout the layers of the part.

At 508, the process 500 may include determining thermal model(s) associated with the slab(s). The thermal model(s) may associate or correlate the slab(s) with one another. For example, the slab(s) may act as a unit as compared to being modeled in isolation in order to form a network on communication that models how heat propagates throughout the slab(s). The thermal model(s) may be used to model strain and/or stress imparted into the part and resulting deformations that occur. The thermal model(s) are used to model how the heat propagates throughout an individual slab, as well as how, the heat propagates to other slabs. In this way, the thermal model(s) are used to “connect” the slab(s) together, as a way to transfer information (e.g., heat) between the slab(s) without assembling or modeling the slabs together. Using the thermal model(s) as a way to connect the slab(s) is a mesh-free approach to model the thermal propagation and stresses imparted to the part. Avoiding a 3D mesh model of the part to understand deformations that results from input strains reduces time, an amount of resources, and may eliminate human intervention.

At 510, the process 500 may include determining an expected deformation of the part based at least in part on the thermal model(s). For example, knowing how heat propagates throughout the part is used to determine the resulting deformations of the part after or during manufacturing. By accurately modeling the propagation of heat, via the thermal model(s), an expected deformation of the part is determined. The accuracy of the deformations is important in order to compensate for these deformations. In other words, knowing the deformations in the part allows for those deformations to be corrected.

At 512, the process 500 may include determining first lasing tasks to manufacture the part. The first lasing tasks may be determined using the thermal model(s), the mechanical model(s), and/or the expected deformations determined from the expected characteristics of the melt pool, or the lasers to create the melt pool. The first lasing tasks may compensate for the expected deformations such that as the part is manufactured, the resultant part is as desired. In order words, as the first lasing tasks are performed, deformations are introduced into the part such that the resulting part is as desired.

At 514, the process 500 may include causing the part to be manufactured. Causing the part to be manufactured may include instructing the laser to emit laser beams to melt powdered metal in accordance with the first lasing tasks. The first lasing tasks may indicate setting(s) associated with causing the performance of the first lasing tasks. Accordingly, the laser beams may melt the powdered metal in accordance with instructions contained in the lasing tasks.

At 516, the process 500 may include receiving imaging beam(s) associated with the part being manufactured. For example, while the part is being manufactured, and as the lasers melt the powdered metal, the imaging sensor(s) may receive the imaging beam(s) associated with a melt pool of the powdered metal. Various information may be gleaned from the imaging beam(s), such as a temperature of the melt pool, an amount of energy of the melt pool, a strain of the melt pool, a size of the melt pool, and so forth.

At 518, the process 500 may include determining, based at least in part on the imaging beam(s), an actual deformation of the part. The actual deformation of the part may be determined, using the thermal model(s), the mechanical model(s), and the actual characteristics of the lasing task and/or the melt pool. For example, based at least in part on the imaging beam(s), the temperature, strain, size, etc., of the melt pool may be determined. This is determined in real-time, as compared to the expected characteristics that are determined prior to manufacturing of the part. During performance of the lasing tasks, the deformations within the part are monitored.

A comparison of the actual characteristics to the expected characteristics is used to understand deviations that occurred during manufacturing of the part. For example, if the lasers manufacture the part as expected, then the expected characteristics and the actual characteristics are similar (or within a threshold percentage, amount, etc.). This permits a known understanding of the deformations within the part that has already been accounted for in the first lasing tasks. By contrast, if the actual characteristics are different than the expected characteristics, the actual deformation may be different than the expected deformation. In this instance, the actual deformation has not been accounted for in the first lasing tasks.

At 520, the process 500 may include determining whether the expected deformation and the actual deformation are similar. In some instances, whether the expected deformation and the actual deformation are similar may be based on the expected deformation and the actual deformation having a threshold similarity. As noted above, when the expected deformation and the actual deformation are similar, the produced part has known deformations that have been accounted for in the first lasing tasks.

If at 520 the process 500 determines that the expected deformation and the actual deformation are similar, the process 500 may follow the “YES” route and proceed to 514. That is, because the manufacturing process is performing as expected, the first lasing tasks may be further carried out. Moreover, when the expected deformation and the actual deformation are similar, a quality of the part may be deemed acceptable. Alternatively, if at 520 the process 500 determines that the expected deformation and the actual deformation are dissimilar, the process 500 may follow the “NO” route and proceed to 522.

At 522, the process 500 may include determining one or more updates to the thermal model(s). For example, based on the actual characteristics of the lasing tasks being performed, the thermal model(s) may update the deformations that are expected to occur based on the actual characteristics. In other words, the thermal propagation may be remodeled to determine the expected deformation by knowing how the part is being manufactured and the actual characteristics associated with manufacturing the part. This expected deformation may be different than previously determined at 510 based on the actual characteristics.

At 524, the process 500 may include determining second lasing tasks to manufacture the part. The second lasing tasks may be based on the updates to the thermal model(s), which are used to understand the energy propagation (based on the actual characteristics) and the effects on the deformations. The second lasing tasks may correct for these deformations. In some instances, the mechanical model(s) utilize outputs of the thermal model(s) to determine the deformation(s). With this process, the imaging beams may be used in real time to adjust the control of the laser beams based on the actual performance of the lasing tasks and the characteristics of the melt pool. The adjustment may consider the actual deformations of the part based on using the thermal model(s) to measure the strain propagation as determined from the imaging beams.

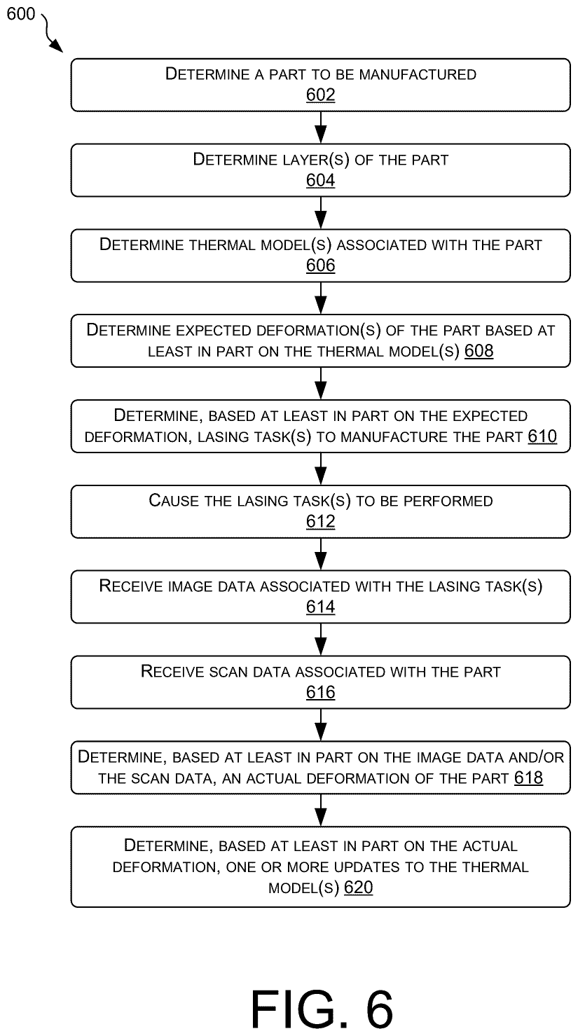

FIG. 6 illustrates an example process 600 associated with determining deformations within a part, and accounting for the deformations during manufacturing, according to examples of the present disclosure. At 602, the process 600 may include determining a part to be manufactured. For example, the 3D printing system 100 may be responsible for manufacturing parts across the build modules 104 via the lasing modules 102. In some instances, the 3D printing system 100 may access, or knowledge, into all the manufactured parts.

At 604, the process 600 may include determining layers of the part. For example, based at least in part on the part being manufactured, the part may be segmented into a plurality of layers. In some instances, the part is segmented into the layers based on a certain desired thickness of the layers, dimensions of the part, a material of the part, and so forth. Each of the layers may include a plurality of lasing tasks that are to be performed for forming the layer of that part. For example, when the lasing tasks of a layer of a part are perform, that layer may be completed.

At 606, the process 600 may include determining thermal model(s) associated with the part. The thermal model(s) may associate, or correlate, the layers of the part with one another. For example, the thermal model(s) may be used to model stress and/or strain imparted into the part as a result of lasing tasks being performed. For example, given the connectedness between the layers, heat propagates throughout the layers and/or the same layer.

At 608, the process 600 may include determining expected deformations of the part based at least in part on the thermal model(s). For example, when the lasing tasks are performed, and based on setting(s) of the lasing task (e.g., time, heat, angle of incident, etc.), stresses and strains may be imparted to the part. These stresses and strains may result in deformations to the part. However, knowing the deformations ahead of time allows for the deformations to be compensated for during manufacturing. If not accounted for, these deformations may generate a part with undesirable features (e.g., shape, size, etc.).

At 610, the process 600 may include determining, based at least in part on the expected deformations, lasing tasks to manufacture the part. For example, lasing tasks for manufacturing the part with desired characteristics may be determined due to determining the deformations. As the lasing tasks are performed, and the stresses and strains are imparted to the part, the stresses and strains may cause deformation so that the finished part may have the desired features. The lasing tasks therefore account for the deformations that occur as a way to compensate for the stresses and strains introduced to the part during manufacturing. This results in a correction to the expected deformations.

At 612, the process 600 may include causing the lasing tasks to be performed. For example, the lasing module 102 may perform the lasing tasks. As part of performing the lasing tasks, the lasers may be controlled to the setting(s).

At 614, the process 600 may include receiving image data associated with the lasing tasks. For example, while the part is being manufactured and the lasing tasks are being carried out, the imaging beams may be received by the imaging sensors. The image data associated with, or determined from, the imaging beams may indicate characteristics of the melt pool (e.g., temperature, stress, strain, size, energy, etc.).

At 616, the process 600 may include receiving scan data associated with the part. For example, after manufacturing of the part, the scanner may be used to generate the scan data. The scan data may indicate a structure of the part. In some instances, the scan data may be used to determine, or indicate three-dimensional information about the part.

At 618, the process 600 may include determining, based at least in part on the image data and/or the scan data, an actual deformation of the part. For example, using the image data and/or the scan data, the deformation of the part may be determined.

At 620, the process 600 may include determining, based at least in part on the actual deformation, one or more updates to the thermal model(s). For example, using the image data and the scan data, whereby the actual deformation is determined, the thermal model(s) may be updated to more accurately model the thermal propagation of the energy throughout the layers of the part during manufacturing. In some instances, the image data and the scan data may be correlated with one in order to understand the affects, or characteristics of the lasing tasks and/or melt pool, with the resulting deformation. Using the updates to the thermal model(s), at future instances, parts may be more accurately manufactured with expected deformations.

While the foregoing invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining a part to be manufactured within a build module of a 3D printing system;
determining a plurality of layers of the part, individual layers of the plurality of layers having one or more lasing tasks to be performed by a lasing module of the 3D printing system for manufacturing the individual layers;
determining, among the plurality of layers, first layers associated with a first slab of the part;
determining, among the plurality of layers, second layers associated with a second slab of the part, the second slab being adjacent to the first slab;
determining a lasing task to be performed on a top-most layer of the first slab;
determining a thermal model associated with a propagation of heat between the first slab and the second slab based at least in part on the lasing task being performed;
determining, based at least in part on the propagation of heat, an expected deformation of the part; and
causing, based at least in part on the expected deformation, the lasing module to generate a laser beam associated with the lasing task.

2. The method of claim 1, further comprising:
receiving data associated with a melt pool within the build module, the melt pool being generated by the laser beam melting powdered metal within the build module;
determining, based at least in part on the data, one or more characteristics of the melt pool;
determining, based at least in part on the thermal model and the one or more characteristics, an actual deformation of the part; and
determining a similarity between the actual deformation and the expected deformation.

3. The method of claim 2, further comprising:
determining that the similarity is greater than a threshold; and
determining, based at least in part on the similarity being greater than the threshold, that a quality of the part is acceptable.

4. The method of claim 2, further comprising:
determining that the similarity is less than a threshold;
determining, based at least in part on the similarity being less than the threshold, that a quality of the part is unacceptable; and
determining, based at least in part on the data, a second thermal model associated with the propagation of heat between the first slab and the second slab.

5. The method of claim 2, wherein the one or more characteristics include at least one of:
a temperature of the melt pool;
a strain associated with the melt pool;
a location of the melt pool on a build area of the build module;
a size of the melt pool; or
an amount of energy associated with the melt pool.

6. The method of claim 1, wherein the thermal model is based at least in part on at least one of:
a shape of the lasing task;
a size of the lasing task;
a location of the lasing task on the top-most layer;
a second lasing task performed prior to the lasing task; or
an amount of energy to perform the lasing task.

7. The method of claim 1, wherein the lasing module includes:
a beamlet having an imaging sensor and a laser configured to generate the laser beam;
the laser beam has a first path through the beamlet; and
the imaging sensor is configured to receive an imaging beam associated with a melt pool within the build module, wherein a second path of the imaging beam through the beamlet at least partially overlaps with the first path.

8. The method of claim 1, further comprising:
determining, among the plurality of layers, third layers associated with a third slab of the part;
determining a second thermal model associated with a second propagation of the heat between the second slab and the third slab based at least in part on the lasing task being performed; and
determining, based at least in part on the second propagation of the heat, the expected deformation of the part.

9. A method comprising:
determining a part to be manufactured by a 3D printing system;
determining a plurality of layers of the part;
determining first layers of the plurality of layers;
determining second layers of the plurality of layers, the second layers being different than the first layers;
associating the first layers with one another;
associating the second layers with one another;
determining a lasing task to be performed on a layer of the first layers, the lasing task being associated the 3D printing system melting powdered metal on the layer via one or more laser beams;
determining a thermal model associated with a propagation of heat between the first layers and the second layers based at least in part on the lasing task being performed;
determining, based at least in part on the propagation of heat, an expected deformation of the part;
receiving data associated with a melt pool of the powdered metal;
determining, based at least in part on the data, an actual deformation of the part; and
determining a similarity between the expected deformation and the actual deformation.

10. The method of claim 9, further comprising determining one or more characteristics associated with the lasing task, the one or more characteristics including at least one of:
an amount of heat associated with performing the lasing task;
a location of the lasing task on a build module of the 3D printing system, the build module having the powdered metal; or
a time associated with performing the lasing task.

11. The method of claim 10, wherein the expected deformation is based at least in part on the one or more characteristics.

12. The method of claim 9, further comprising determining, based at least in part on the data, one or more characteristics associated with the melt pool, the one or more characteristics including at least one of:
a temperature of the melt pool;
a strain associated with the melt pool;
a location of the melt pool on a build area of the 3D printing system;
a size of the melt pool; or
an amount of energy associated with the melt pool.

13. The method of claim 9, further comprising based at least in part on the similarity, determining whether a quality of the part is acceptable.

14. The method of claim 9, wherein:
the lasing task is associated with one or more first characteristics;
the data is associated with one or more second characteristics of the melt pool;
the expected deformation is based at least in part on the one or more first characteristics; and
the actual deformation is based at least in part on the one or more second characteristics.

15. The method of claim 9, wherein:
an amount of energy associated with lasing task; and
the thermal model indicates the propagation of heat based at least in part on the amount of energy.

16. The method of claim 9, wherein:
an amount of strain introduced to the part based on performance of the lasing task; and
the thermal model indicates a second propagation of stress throughout the part based at least in part on the amount of strain.

17. A method comprising:
determining a part to be manufactured by a 3D printing system;
determining a plurality of layers of the part;
determining, among the plurality of layers, first layers associated with a first slab of the part;
determining, among the plurality of layers, second layers associated with a second slab of the part, the second slab being adjacent to the first slab;
determining a lasing task to be performed on a top-most layer of the first slab;
determining a thermal model associated with a propagation of heat between the first slab and the second slab based at least in part on the lasing task being performed;
determining, based at least in part on the propagation of heat, a first deformation of the part;
receiving, during performance of the lasing task, an imaging beam associated with a melt pool; and
determining, based at least in part on the imaging beam, a second deformation of the part.

18. The method of claim 17, further comprising determining a similarity between the first deformation and the second deformation.

19. The method of claim 17, further comprising receiving, after manufacturing of the part, scan data associated with a structure of the part.

20. The method of claim 17, further comprising:
determining, based at least in part on the lasing task, first characteristics of the melt pool;
determining, based at least in part on the imaging beam, second characteristics of the melt pool,
wherein:
the first deformation is based at least in part on the first characteristics, and
the second deformation is based at least in part on the second characteristics.
